(19) United States
(12) Patent Application Publication
(10) Pub. No.: US 2011/0177960 A1
(43) Pub. Date: Jul. 21, 2011

(54) Microarray for monitoring gene expression in multiple strains of Streptococcus pneumoniae

(76) Inventors: Ellen Murphy, City Island, NY (US); William Martin Mounts, Andover, MA (US)

(21) Appl. No.: 11/716,128

(22) Filed: Mar. 9, 2007

Related U.S. Application Data
(60) Provisional application No. 60/781,532, filed on Mar. 10, 2006.

(51) Int. Cl. C40B 30/04; C40B 40/06

(52) U.S. Cl. 506/9; 506/16

(57) ABSTRACT

The present invention features an array capable of monitoring gene expression patterns of multiple strains of Streptococcus pneumoniae including a substrate having a plurality of addresses, each of which has a probe disposed thereon.

### CROSS-REFERENCE TO RELATED APPLICATIONS

This application claims priority to and the benefit of U.S. Provisional Patent Application No. 60/781,532, filed on Mar. 10, 2006, the entire contents of which are incorporated by reference herein.

This application contains two compact discs labeled “Copy 1” and “Copy 2” containing the sequence listing. The materials recorded in each of the compact discs labeled “Copy 1” and “Copy 2” are incorporated herein by reference in their entireties. The compact discs labeled “Copy 1” and “Copy 2” each contains a single file named “WYE-057.txt” (136,4371(B, created on Mar. 9, 2006). The compact discs were created on Mar. 8, 2007.

### TECHNICAL FIELD

This invention relates to nucleic acid arrays and methods of using the same for concurrent or discriminable detection of different strains of Streptococcus pneumoniae.

### BACKGROUND OF THE INVENTION

Streptococcus pneumoniae (S. pneumoniae) is a common, spherical, gram-positive bacterium. Worldwide it is a leading cause of illness among children, the elderly, and individuals with debilitating medical conditions (Breiman, R. F., 1994, JAMA 271: 1831). Specifically, S. pneumoniae is the most common pathogenic cause of bacterial pneumonia, and is also one of the major causes of bacterial otitis media (middle ear infections), meningitis and bacteremia. Statistically, S. pneumoniae is estimated to be the causal agent in 3,000 cases of meningitis, 50,000 cases of bacteremia, 500,000 cases of pneumonia, and 7,000,000 cases of otitis media annnually in the United States alone (Reichler, M. R. et al., 1992, J. Infect. Dis. 166: 1346; Stool, S. E. and Field, M. J., 1989 Pediatr. Infect. Dis. J. 8: S11). In the United States alone, 40,000 deaths result annually from S. pneumoniae infections (Williams, W. W. et al., 1988 Ann. Intern. Med. 108: 616) with a death rate approaching 30% from bacteremia (Butler, J. C. et al., 1993, JAMA 270: 1826). Pneumococcal pneumonia is a serious problem among the elderly of industrialized nations (Kayhty, H. and Eskola, J., 1996 Emerg. Infect. Dis. 2: 289) and is a leading cause of death among children in developing nations (Kayhty, H. and Eskola, J., 1996 Emerg. Infect. Dis. 2: 289; Stansfield, S. K., 1987 Pediatr. Infect. Dis. 6: 622).

The ability to promptly identify and classify different pathogens is often pivotal to the diagnosis, prophylaxis, or treatment of infectious disease. Traditional detection methods such as 16S DNA analyses, serotyping or ribotyping are laborious, and many of these methods are incapable of discriminably detecting multiple strains of Streptococcus pneumoniae at the same time. Therefore, there is a need for new methods that would allow rapid, accurate and discriminable detection of Streptococcus pneumoniae.

In addition, one major challenge in Streptococcus pneumoniae treatment is that Streptococcus pneumoniae has developed resistance to most antibiotics used for its treatment. In fact, it is common for Streptococcus pneumoniae to become resistant to more than one class of antibiotic, e.g., β-lactams, macrolides, lincosamides, trimethoprim-sulfamethoxazole, and tetracyclines (Tauber, 2000), meaning Streptococcus pneumoniae treatment is becoming more difficult.

Thus, the rapid emergence of multi-drug resistant pneumococcal strains throughout the world has led to increased emphasis on prevention of pneumococcal infections by immunization (Goldstein and Garau, 1997). There are about 90 types of the pneumococcal organism, each with a different chemical structure of the capsular polysaccharide. The capsular polysaccharide is the principal virulence factor of the pneumococcus and induces an antibody response in adults. A 23 valent polysaccharide vaccine (23vPS) is available and recommended for use in adults over the age of 65 years of age, and in a variety of high risk patient populations older than 2 years of age. However, 23vPS is not effective in children of less than 2 years of age or in immunocompromised patients, two of the major populations at risk from pneumococcal infection (Douglas et al., 1983). A 7-valent pneumococcal polysaccharide-protein conjugate vaccine was shown to be highly effective in infants and children against systemic pneumococcal disease caused by the vaccine serotypes and against cross-reactive capsular serotypes (Shinefield and Black, 2000). The seven capsular types cover greater than 80% of the invasive disease isolates in children in the United States, but only 57-60% of disease isolates in other areas of the world (Hausdorff et al., 2000).

Laboratories therefore continue to search for additional candidates that are antigenically conserved and elicit antibodies that reduce colonization (important for otitis media), are protective against systemic disease, or both. Thus, there is an immediate need for a cost-effective vaccine to cover most or all of the disease causing serotypes of Streptococcus pneumoniae and methods of diagnosing Streptococcus pneumoniae infection.

A better understanding of the genetic expression patterns of Streptococcus pneumoniae will provide the basis for further development of preventative treatments, therapeutic treatments, new diagnostics and vaccine strategies which are specific for Streptococcus pneumoniae.

### SUMMARY OF THE INVENTION

The present invention provides compositions and methods for better understanding of the genetic expression patterns of Streptococcus pneumoniae. The present invention provides compositions and methods that would allow rapid, accurate and discriminable detection of strains of Streptococcus pneumoniae.

In particular, the present invention provides probe arrays capable of monitoring gene expression in multiple strains of Streptococcus pneumoniae. The present invention also provides probe arrays that allow for concurrent and discriminable detection of multiple strains of Streptococcus pneumoniae.

Thus, in one aspect, the present invention features an array capable of monitoring gene expression patterns of multiple strains of Streptococcus pneumoniae including a substrate having a plurality of addresses, each of which has at least one probe disposed thereon. In one embodiment, the array of the invention includes probes that are oligonucleotides derived from genomic consensus sequences of Streptococcus pneumoniae using a probe selection algorithm. In some embodiments, each probe is an oligonucleotide having a length of 10-50 bases. In some embodiments, the probes are perfect match probes. In other embodiments, the probes are mismatch probes with at least one mismatch position located at the approximate thermodynamic center of each probe.

In preferred embodiments, the probes suitable for the present invention are derived from the genomic consensus sequences including one or more sequences selected from the group consisting of SEQ ID NOs: 1-5980 and 7782-7870. In preferred embodiments, the probes suitable for the present invention are derived from genomic consensus sequences including ten or more sequences selected from the group consisting of SEQ ID NOs: 1-5980 and 7782-7870. In preferred embodiments, the probes suitable for the present invention are derived from genomic consensus sequences including one hundred or more sequences selected from the group consisting of SEQ ID NOs: 1-5980 and 7782-7870. More preferably, probes derived from each of SEQ ID NOs: 1-5980 and 7782-7870 are used.

In some embodiments, the array of the invention further includes at least one additional probe derived from exemplar sequences of Streptococcus pneumoniae using a probe selection algorithm. The additional probe can be derived from one or more sequences selected from the group consisting of SEQ ID NOs: 5981-7757 and 7871-7915. Preferably, the additional probe is derived from the exemplar sequences including ten or more sequences selected from the group consisting of SEQ ID NOs: 5981-7757 and 7871-7915. More preferably, the additional probe is derived from the exemplar sequences including one hundred or more sequences selected from the group consisting of SEQ ID NOs: 5981-7757 and 7871-7915.

In one particular embodiment, the array of the invention includes probes derived from SEQ ID NOs: 1-7924 by a probe selection algorithm.

In particular, an array of the present invention is capable of monitoring gene expression patterns of one or more Streptococcus pneumoniae strains selected from the group consisting of R6, TIGR4, 23F, ATCC55840 and TIGR 670.

In another aspect, the present invention provides methods for identifying a serotype of a strain of Streptococcus pneumoniae in a sample, including the steps of exposing the sample to an array of the invention as described in various embodiments above; and detecting a gene expression pattern indicative of the serotype.

In yet another aspect, the present invention provides methods for detecting the presence of Streptococcus pneumoniae in a sample, including the steps of exposing the sample to an array of the invention as described in various embodiments above; and detecting a gene expression pattern indicative of the presence of Streptococcus pneumoniae. In particular, the method of the present invention may be used to detect a disease-associated strain of Streptococcus pneumoniae. In one embodiment, the sample is a biological sample from a patient. In another embodiment, the sample is from a culture of Streptococcus pneumoniae.

In yet another aspect, the present invention provides a method for monitoring gene expression using the array of the invention as described in various embodiments above.

Other features, objects, and advantages of the present invention are apparent in the detailed description that follows. It should be understood, however, that the detailed description, while indicating preferred embodiments of the invention, is given by way of illustration only, not limitation. Various changes and modifications within the scope of the invention will become apparent to those skilled in the art from the detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings are provided for illustration, not limitation.

FIG. 1 illustrates a dendrogram-heat map showing DNA similarity between isolates using Spneumo1 array. Each column represents one strain; each row represents a gene. Red indicates a strong signal for a gene present in that strain; blue indicates the gene is absent; and intermediate orange-yellow-green color represents a weaker signal, indicating, perhaps, a gene variant.

FIG. 2 illustrates a dendrogram-heat map showing 20 qualifiers predicted to be present in serotype 1.

FIG. 3 illustrates a dendrogram-heat map showing 20 qualifiers predicted to be present in serotype 5.

FIG. 4 illustrates a dendrogram-heat map showing 28 qualifiers predicted to be present in serotype 18F.

FIG. 5 illustrates a dendrogram-heat map showing 27 qualifiers predicted to be present in serotype 18C.

FIG. 6 illustrates a dendrogram-heat map showing 39 qualifiers predicted to be present in serotypes 6A or 6B.

FIG. 7 illustrates a dendrogram-heat map showing the presence of rhamnosyltransferase unique to serotypes 6A and 6B.

FIG. 8 illustrates a dendrogram-heat map showing virulence gene pspA profile in different serotypes.

FIG. 9 illustrates a dendrogram-heat map showing virulence gene pspC profile in different serotypes.

The sequence information of qualifiers used in the Figures is shown in Table 3.

### DETAILED DESCRIPTION OF THE INVENTION

The present invention provides compositions and methods which allow concurrent or discriminable detection of different strains of Streptococcus pneumoniae. In particular, the present invention provides nucleic acid arrays capable of detecting or monitoring gene expression patterns in multiple strains of Streptococcus pneumoniae. In preferred embodiments, the nucleic acid arrays of the present invention include probes derived from genomic consensus sequences of Streptococcus pneumoniae using a probe selection algorithm. Thus, the present invention represents a significant advance in diagnosis and treatment of Streptococcus pneumoniae.

Various aspects of the invention are described in further detail in the following subsections. The use of subsections is not meant to limit the invention. Each subsection may apply to any aspect of the invention. In this application, the use of “or” means “and/or” unless stated otherwise.

Different strains of a species have different genetic properties. These genetic differences are often manifested in gene expression profiles and therefore become detectable by using the probe arrays of the present invention. The present invention contemplates discriminable detection of different strains that have distinguishable phenotypical characteristics, such as different immunological, morphological, or antibiotic-resistance properties. The present invention also contemplates discriminable detection of strains that have no distinguishable phenotypical properties. As used herein, “strain” includes subspecies.

### Identification of Open Reading Frames and Intergenic Sequences

Open reading frames (ORFs) and intergenic sequences of different Streptococcus pneumoniae strains can be derived from their genomic sequences. A number of Streptococcus pneumoniae genomes are available from a variety of public sources. Table 1 lists five exemplary Streptococcus pneumoniae strains and the sources from which their genomic sequences can be obtained.

TABLE 1
Genomes of Streptococcus pneumoniae Strains

| Strain Name | Genome Status | Source |
|---|---|---|
| R6 | Complete | GenBank ® Accession number |
| | | AE007317 |
| TIGR 4 | Complete | The Microbial Database at The |
| | | Institute for Genome Research |
| | | (TIGR) |
| 23F | Incomplete | Sanger Centre (United Kingdom) |
| ATCC 55840 | Incomplete | Human Genome Sciences, Inc. |
| TIGR 670 | Incomplete | The Microbial Database at The |
| | | Institute for Genome Research |
| | | (TIGR) |

In addition, the sequences of capsule biosynthetic operons representing 90 serotypes from the Sanger Institute, and additional sequences from GenBank® and Pathoseq™ database (Incyte™) were also included in the alignments.

ORFs can be collected as those annotated in public records and can also be predicted or isolated by various methods. Exemplary methods include, but are not limited to, GeneMark® (such as GeneMark® 1.2.4a, provided by the European Bioinformatics Institute), Glimmer (such as Glimmer 2.13, provided by TIGR), and ORF Finder (provided by the National Center for Biotechnology Information (NCBI)).

Suitable clustering algorithms for this purpose include, but are not limited to, the CAT (cluster and alignment tool, e.g., CAT 4.5) software package provided by DoubleTwist™. See Clustering and Alignment Tools User's Guide (DoubleTwist, Inc., 2000).

The CAT program can cause all similar ORFs to cluster together, and then align those similar ORFs to generate one or more sub-clusters. Each sub-cluster of two or more members generates a consensus sequence. The consensus sequences can be generated such that any base ambiguity would be identified with the respective IUPAC (International Union of Pure and Applied Chemistry) base representation, which is consistent with the WIPO Standard ST.25 (1998).

The consensus sequences, in addition to all singleton sequences that are either excluded in the initial clustering or sub-clustered into a singleton sub-cluster, can be manually curated to verify cluster membership. At this stage, some clusters can be joined or separated based on known homologies that are not identified with CAT. Moreover, filtered intergenic sequences can be added to the final set of sequences which are used for generating the nucleic acid array probes. tRNA and rRNA sequences may also be added. These consensus sequences can also be manually curated to remove highly repetitive regions, particularly those associated with surface proteins. Large transcripts can be broken into segments not exceeding 5,000 nt.

Examples of the consensus sequences identified using the above-described method are depicted in SEQ ID NOs: 1-5980 and 7782-7870. See the Sequence Listing.

Probes for Detecting Multiple Strains of Streptococcus pneumoniae

The consensus sequences can be used to prepare probes that are common to the Streptococcus pneumoniae strains from which the sequences were derived. As used herein, a polynucleotide probe is “common” to a group of strains if the polynucleotide probe can hybridize under stringent conditions to each and every strain selected from the group. A polynucleotide can hybridize to a strain if the polynucleotide can hybridize to an RNA transcript, or the complement thereof, of the strain. In many embodiments, a probe common to a group of strains can hybridize under stringent conditions to a protein-coding sequence (e.g., an exon or the protein-coding region of an mRNA), or the complement thereof, of each strain in the group. In many other embodiments, a probe common to a group of strains does not hybridize under stringent conditions to RNA transcripts, or the complements thereof, of other strains of the same species or strains of other species.

“Stringent conditions” are at least as stringent as, for example, conditions G-L shown in Table 2. In certain embodiments of the present invention, highly stringent conditions A-F can be used. In Table 2, hybridization is carried out under the hybridization conditions (Hybridization Temperature and Buffer) for about four hours, followed by two 20-minute washes under the corresponding wash conditions (Wash Temp. and Buffer).

TABLE 2
Stringency Conditions

| | Poly- | | | |
|---|---|---|---|---|
| Stringency | nucleotide | Hybrid | Hybridization | Wash Temp. |
| Condition | Hybrid | Length (bp)¹ | Temperature and Buffer^{H} | and Buffer^{H} |
| A | DNA:DNA | >50 | 65° C.; 1xSSC -or- | 65° C.; 0.3xSSC |
| | | | 42° C.; 1xSSC, 50% formamide | |
| B | DNA:DNA | <50 | T_{B}*; 1xSSC | T_{B}*; 1xSSC |
| C | DNA:RNA | >50 | 67° C.; 1xSSC -or- | 67° C.; 0.3xSSC |
| | | | 45° C.; 1xSSC, 50% formamide | |
| D | DNA:RNA | <50 | T_{D}*; 1xSSC | T_{D}*; 1xSSC |
| E | RNA:RNA | >50 | 70° C.; 1xSSC -or- | 70° C.; 0.3xSSC |
| | | | 50° C.; 1xSSC, 50% formamide | |
| F | RNA:RNA | <50 | T_{F}*; 1xSSC | T_{f}*; 1xSSC |
| G | DNA:DNA | >50 | 65° C.; 4xSSC -or- | 65° C.; 1xSSC |
| | | | 42° C.; 4xSSC, 50% formamide | |
| H | DNA:DNA | <50 | T_{H}*; 4xSSC | T_{H}*; 4xSSC |
| I | DNA:RNA | >50 | 67° C.; 4xSSC -or- | 67° C.; 1xSSC |
| | | | 45° C.; 4xSSC, 50% formamide | |
| J | DNA:RNA | <50 | T_{J}*; 4xSSC | T_{J}*; 4xSSC |
| K | RNA:RNA | >50 | 70° C.; 4xSSC -or- | 67° C.; 1xSSC |
| | | | 50° C.; 4xSSC, 50% formamide | |
| L | RNA:RNA | <50 | T_{L}*; 2xSSC | T_{L}*; 2xSSC |

¹The hybrid length is that anticipated for the hybridized region(s) of the hybridizing polynucleotides. When hybridizing a polynucleotide to a target polynucleotide of unknown sequence, the hybrid length is assumed to be that of the hybridizing polynucleotide. When polynucleotides of known sequence are hybridized, the hybrid length can be determined by aligning the sequences of the polynucleotides and identifying the region or regions of optimal sequence complementarity.
^{H}SSPE (1xSSPE is 0.15M NaCl, 10 mM NaH₂PO₄, and 1.25 mM EDTA, pH 7.4) can be substituted for SSC (1xSSC is 0.15M NaCl and 15 mM sodium citrate) in the hybridization and wash buffers.
T_{B}* − T_{R}*: The hybridization temperature for hybrids anticipated to be less than 50 base pairs in length should be 5-10° C. less than the melting temperature (Tₘ) of the hybrid, where Tₘ is determined according to the following equations. For hybrids less than 18 base pairs in length, Tₘ(° C.) = 2(# of A + T bases) + 4(# of G + C bases). For hybrids between 18 and 49 base pairs in length, Tₘ(° C.) = 81.5 + 16.6(log₁₀Na⁺) + 0.41(% G + C) − (600/N), where N is the number of bases in the hybrid, and Na⁺ is the molar concentration of sodium ions in the hybridization buffer (Na⁺ for 1xSSC = 0.165M).

Examples of the singleton sequences identified using the above-described clustering method, as well as a filtered set of intergenic sequences, are depicted in SEQ ID NOs: 5981-7757 and 7871-7915. These sequences are herein referred to as “exemplar” sequences. See the Sequence Listing.

Each of the singleton sequences is unique to only one Streptococcus pneumoniae strain. Each singleton sequence can be used to prepare probes that are specific to the Streptococcus pneumoniae strain from which the singleton sequence was derived. As used herein, a polynucleotide probe is “specific” to a strain selected from a group of strains if the polynucleotide probe is capable of hybridizing under stringent conditions to an RNA transcript, or the complement thereof, of the strain, but is incapable of hybridizing under the same conditions to RNA transcripts, or the complements thereof, of other strains in the group. In many embodiments, a probe specific for a strain can hybridize under stringent conditions to a protein-coding sequence (e.g., an exon or the protein-coding region of an mRNA), or the complement thereof, of the strain, but not RNA transcripts, or the complements thereof, of other strains of the same species or strains of other species.

As appreciated by one of ordinary skill in the art, ORFs and other expressible sequences can be similarly extracted from the genomic sequences of other Streptococcus pneumoniae strains. The extracted sequences can be clustered to obtain consensus and singleton sequences. Probes common to two or more strains or probes specific to a particular strain can be derived from the consensus or singleton sequences, respectively.

### Probe Selection

Probes may be selected from the consensus and exemplar sequences depicted in SEQ ID NOs: 1-5980, 5981-7757, 7782-7870, and 7871-7915 using a probe selection algorithm. Control sequences, such as SEQ ID NOs: 7758-7781 and 7916-7924, are also optionally included for probe selection. SEQ ID NOs. 1-7924 are collectively referred to as the “parent sequences.” The probes for each parent sequence can hybridize under stringent or nucleic acid array hybridization conditions to the parent sequence, or the complement thereof. In many embodiments, the probes for each parent sequence are incapable of hybridizing under stringent or nucleic acid array hybridization conditions to other parent sequences, or the complements thereof. In one embodiment, the probes for each parent sequence comprise or consist of a sequence fragment of the parent sequence, or the complement thereof.

As used herein, “nucleic acid array hybridization conditions” refer to the temperature and ionic conditions that are normally used in nucleic acid array hybridization. These conditions include, but are not limited to, 16-hour hybridization at 45° C., followed by at least three 10-minute washes at room temperature. The hybridization buffer comprises 100 mM MES, 1 M [Na], 20 mM EDTA, and 0.01% Tween 20. The pH of the hybridization buffer can range between 6.5 and 6.7. The wash buffer is 6×SSPET. 6×SSPET contains 0.9 M NaCl, 60 mM NaH₂PO₄, 6 mM EDTA, and 0.005% Triton X-100. Under more stringent nucleic acid array hybridization conditions, the wash buffer can contain 100 mM MES, 0.1 M [Na], and 0.01% Tween 20.

The probes of the present invention can be DNA, RNA, or PNA. Other modified forms of DNA, RNA, or PNA can also be used. The nucleotide units in each probe can be either naturally occurring residues (such as deoxyadenylate, deoxycytidylate, deoxyguanylate, deoxythymidylate, adenylate, cytidylate, guanylate, and uridylate), or synthetically produced analogs that are capable of forming desired base-pair relationships. Examples of these analogs include, but are not limited to, aza and deaza pyrimidine analogs, aza and deaza purine analogs, and other heterocyclic base analogs, wherein one or more of the carbon and nitrogen atoms of the purine and pyrimidine rings are substituted by heteroatoms, such as oxygen, sulfur, selenium, and phosphorus. Similarly, the polynucleotide backbones of the probes of the present invention can be either naturally occurring (such as through 5′ to 3′ linkage), or modified. For instance, the nucleotide units can be connected via non-typical linkage, such as 5′ to 2′ linkage, so long as the linkage does not interfere with hybridization. For another instance, peptide nucleic acids, in which the constitute bases are joined by peptide bonds rather than phosphodiester linkages, can be used.

In one embodiment, the probes have relatively high sequence complexity. In many instances, the probes do not contain long stretches of the same nucleotide. In another embodiment, the probes can be designed such that they do not have a high proportion of G or C residues at the 3′ ends. In yet another embodiment, the probes do not have a 3′ terminal T residue. Depending on the type of assay or detection to be performed, sequences that are predicted to form hairpins or interstrand structures, such as “primer dimers,” can be either included in or excluded from the probe sequences. In many embodiments, each probe employed in the present invention does not contain any ambiguous base.

Any part of a parent sequence can be used to prepare probes. For instance, probes can be prepared from the protein-coding region, the 5′ untranslated region, or the 3′ untranslated region of a parent sequence. Multiple probes, such as 5, 10, 15, 20, 25, 30, 50, 70, or more, can be prepared for each parent sequence. The multiple probes for the same parent sequence may or may not overlap each other. Overlap among different probes may be desirable in some assays.

In many embodiments, the probes for a parent sequence have low sequence identities with other parent sequences, or the complements thereof. For instance, each probe for a parent sequence can have no more than 70%, 60%, 50% or less sequence identity with other parent sequences, or the complements thereof. This reduces the risk of undesired cross-hybridization. Sequence identity can be determined using methods known in the art. These methods include, but are not limited to, BLASTN, FASTA, FASTDB, and the GCG program.

The suitability of the probes for hybridization can be evaluated using various computer programs. Suitable programs for this purpose include, but are not limited to, LaserGene® (DNAStar), Oligo® (National Biosciences, Inc.), MacVector® (Kodak/IBI), and the standard programs provided by the Genetics Computer Group® (GCG).

In one embodiment, the parent sequences with large sizes are divided into shorter sequence segments to facilitate the probe design. These shorter sequence segments, together with the remaining undivided parent sequences, are collectively referred to as the “tiling” sequences.

Polynucleotide probes can be derived from the tiling sequences. The probes for each tiling sequence can hybridize under stringent or nucleic acid array hybridization conditions to that tiling sequence, or the complement thereof. In many embodiments, the probes for each tiling sequence are incapable of hybridizing under stringent or nucleic acid array hybridization conditions to other tiling sequences, or the complements thereof.

Polynucleotide probes can be generated using a probe selection algorithm known to one skilled in the art. In one embodiment, probes may be derived from consenses sequences using a probe selection algorithm as described in Mei R. et al. (2003) “Probe selection for high-density oligonucleotide arrays,” PNAS U.S.A., 100(20):11237-42, the teachings of which are hereby incorporated by reference. Examples of the polynucleotide probes thus generated are depicted in SEQ ID NOs: 7,925-254,193.

In another embodiment, probes may be generated by using Array Designer 2.0 (Premier Biosoft International) with standard defaults selected and requesting probes 25 by in length. Additionally, probes were selected to ensure no ambiguities existed in the probe sequence, that each probe sequence was represented not more than one time for all sequences submitted for probe selection, and that the mismatch probe was not present in the sequences submitted for probe selection. From the probes remaining after these exclusions, the thirty-four probes with the best probe scores as determined by Array Designer were selected for array design. Examples of the polynucleotide probes thus generated are depicted in SEQ ID NOs: 254,194-478,375.

Other methods or software programs can also be used to prepare probes from the parent sequences of the present invention.

Probes may be designed by a perfect match-mismatch probe layout. A perfect match probe may be a 25-mer oligonucleotide that perfectly and unambiguously matches the target sequence; while a mismatch probe is the same except for a single-base mismatch at position 13 of the probe. Single-base mismatches are illustrated as follows. If the perfect match base at position 13 is an adenine, the mismatch base is represented as a thymine. If a perfect match base at position 13 is a thymine, the mismatch base is represented as an adenine. If a perfect match base at position 13 is a guanine, the mismatch base is represented as a cytosine. If a perfect match base at position 13 is a cytosine, the mismatch base is represented as a guanine.

In one embodiment, perfect mismatch probes are prepared for each probe of the present invention. A perfect mismatch probe has the same sequence as the original probe (i.e., the perfect match probe) except for a homomeric substitution (A to T, T to A, G to C, and C to G) at or near the center of the perfect mismatch probe. For instance, if the original probe has 2n nucleotide residues, the homomeric substitution in the perfect mismatch probe is either at the n or n+1 position, but not at both positions. If the original probe has 2n+1 nucleotide residues, the homomeric substitution in the perfect mismatch probe is at the n+1 position.

The polynucleotide probes of the present invention can be synthesized using a variety of methods. Examples of these methods include, but are not limited to, the use of automated or high throughput DNA synthesizers, such as those provided by Millipore®, GeneMachines®, and BioAutomation. In many embodiments, the synthesized probes are substantially free of impurities. In many other embodiments, the probes are substantially free of other contaminants that may hinder the desired functions of the probes. The probes can be purified or concentrated using numerous methods, such as reverse phase chromatography, ethanol precipitation, gel filtration, electrophoresis, or any combination thereof.

### Nucleic Acid Arrays

The polynucleotide probes of the present invention may be used to make nucleic acid arrays. In many embodiments, the nucleic acid arrays of the present invention include at least one substrate support which has a plurality of addresses. The location of each of these addresses is either known or determinable. The addresses can be organized in various forms or patterns. For instance, the addresses can be spaced regularly on a surface of the substrate. Other regular or irregular patterns, such as linear, concentric or spiral patterns, can be used.

One or more polynucleotide probes can be stably disposed on (or attached to) each address through covalent or non-covalent interactions. As used herein, a polynucleotide probe is “stably” disposed on (or attached to) an address if the polynucleotide probe retains its position relative to the address during nucleic acid array hybridization.

Any method may be used to attach polynucleotide probes to an substrate of a nucleic acid array. In one embodiment, polynucleotide probes are covalently attached to a substrate support by first depositing the polynucleotide probes to respective addresses on the surface of the substrate support and then exposing the surface to a solution of a cross-linking agent, such as glutaraldehyde, borohydride, or other bifunctional agents. In another embodiment, polynucleotide probes are covalently bound to a substrate via an alkylamino-linker group or by coating a substrate (e.g., a glass slide) with polyethylenimine followed by activation with cyanuric chloride for coupling the polynucleotides. In yet another embodiment, polynucleotide probes are covalently attached to a nucleic acid array substrate through polymer linkers. The polymer linkers may improve the accessibility of the probes to their purported targets. Generally, the polymer linkers are not involved in the interactions between the probes and their purported targets.

Polynucleotide probes can also be stably attached to a substrate of an array through non-covalent interactions. In one embodiment, polynucleotide probes are attached to the substrate through electrostatic interactions between positively charged surface groups and the negatively charged probes. In another embodiment, the substrate employed in the present invention is a glass slide having a coating of a polycationic polymer on its surface, such as a cationic polypeptide. The polynucleotide probes are bound to these polycationic polymers. Additional methods described in U.S. Pat. No. 6,440,723 can be used to stably attach polynucleotide probes to a substrate, the teachings of which are hereby incorporated by reference.

Numerous materials can be used to make the substrate support(s) of a nucleic acid array of the present invention. Suitable materials include, but are not limited to, glass, silica, ceramics, nylon, quartz wafers, gels, metals, and paper. The substrate supports can be flexible or rigid. In one embodiment, they are in the form of a tape that is wound up on a reel or cassette. Two or more substrate supports can be used in the same nucleic acid array. Typically, the substrate supports are non-reactive with reagents that are used in nucleic acid array hybridization.

The surface(s) of a substrate support can be smooth and substantially planar. The surface(s) of the substrate can also have a variety of configurations, such as raised or depressed regions, trenches, v-grooves, mesa structures, or other regular or irregular configurations. The surface(s) of the substrate can be coated with one or more modification layers. Suitable modification layers include inorganic or organic layers, such as metals, metal oxides, polymers, or small organic molecules. In one embodiment, the surface(s) of the substrate is chemically treated to include groups such as hydroxyl, carboxyl, amine, aldehyde, or sulfhydryl groups.

The addresses on a nucleic acid array of the present invention can be of any size, shape and density. For instance, they can be squares, ellipsoids, rectangles, triangles, circles, or other regular or irregular geometric shapes, or any portion or combination thereof. Addresses can also be divided into discrete regions. Each of the discrete regions may have a surface area of less than 10⁻¹ cm², such as less than 10⁻², 10⁻³, 10⁴, 10⁻⁵, 10⁻⁶, or 10⁻⁷ cm². Typically, the spacing between each discrete region and its closest neighbor, measured from center-to-center, is in the range of from about 10 to about 400 μm. The density of the discrete regions may range, for example, between 50 and 50,000 regions/cm².

In one embodiment, a nucleic acid array of the present invention is a bead array which includes a plurality of beads. Each bead is stably associated with one or more polynucleotide probes of the present invention.

A variety of methods can be used to make the nucleic acid arrays of the present invention. For instance, the probes can be synthesized in a step-by-step manner on a substrate, or can be attached to a substrate in pre-synthesized forms. Algorithms for reducing the number of synthesis cycles can be used. In one embodiment, a nucleic acid array of the present invention is synthesized in a combinational fashion by delivering monomers to the addresses through mechanically constrained flowpaths. In another embodiment, a nucleic acid array of the present invention is synthesized by spotting monomer reagents onto a substrate support using an ink jet printer (such as the DeskWriter C manufactured by Hewlett-Packard®). In yet another embodiment, polynucleotide probes are immobilized on a nucleic acid array by using photolithography techniques.

In one embodiment, a nucleic acid array of the present invention includes at least two polynucleotide probes, each of which is specific to a different strain of Streptococcus pneumoniae. Strain-specific probes can be prepared from the singleton sequences or other expressible sequences that are unique to that strain. In another embodiment, the nucleic acid array includes at least three, four, five, six, seven, eight, nine, ten, or more polynucleotide probes, each of which is specific to a different respective strain of Streptococcus pneumoniae.

In another embodiment, a nucleic acid array of the present invention includes at least one polynucleotide probe which is common to two or more different strains of Streptococcus pneumoniae. The common probe(s) can hybridize under stringent or nucleic acid array hybridization conditions to each and every strain selected from the two or more different strains. In still yet another embodiment, a nucleic acid array of the present invention includes at least one probe which is common to all of the different strains that are being investigated. This type of common probe can be derived from an ORF or a consensus sequence that is highly conserved among all of the different strains.

In a further embodiment, a nucleic acid array of the present invention includes two or more different polynucleotide probes that are specific to the same strain. For instance, a nucleic acid array can contain at least 5, 10, 20, 50, 100, 200 or more different probes, each of which is specific to the same strain. These different probes can hybridize under stringent or nucleic acid array hybridization conditions to the same RNA transcript, or different RNA transcripts of the same strain. They can be positioned in the same discrete region on a nucleic acid array. They can also be positioned in different discrete regions on a nucleic acid array.

In another embodiment, a nucleic acid array of the present invention can concurrently or discriminably detect two or more Streptococcus pneumoniae strains. Exemplary Streptococcus pneumoniae strains include, but are not limited to, R6, TIGR 4, 23F, ATCC 55840 and TIGR 670. A nucleic acid array of the present invention can include at least two probes, each of which is specific to a different respective strain selected from the above Streptococcus pneumoniae strains. In one embodiment, a nucleic acid array of the present invention includes at least two, three, four, five, or six probes, each of which is specific to a different respective Streptococcus pneumoniae strain selected from R6, TIGR 4, 23F, ATCC 55840 and TIGR 670.

Typically, a nucleic acid array of the present invention contains at least one probe common to two or more Streptococcus pneumoniae strains selected from R6, TIGR 4, 23F, ATCC 55840 and TIGR 670. In another embodiment, the common probe(s) can hybridize under stringent or nucleic acid array hybridization conditions to each and every strain selected from R6, TIGR 4, 23F, ATCC 55840 and TIGR 670.

In one embodiment, a nucleic acid array of the present invention includes polynucleotide probes which can hybridize under stringent or nucleic acid array hybridization conditions to respective sequences selected from SEQ ID NOs: 1 to 7,924 or the complements thereof. In one example, the nucleic acid array includes at least 2, 5, 10, 20, 30, 40, 50, 100, 200, 500, 1,000, 2,000, 3,000, 4,000, 5,000, or more different probes, each of which can hybridize under stringent or nucleic acid array hybridization conditions to a different respective sequence selected from SEQ ID NOs: 1 to 7,924, or the complement thereof. As used herein, two polynucleotides are “different” if they have different nucleic acid sequences.

The length of a probe can be selected to achieve the desired hybridization effect. For instance, a probe can include or consist of 15, 20, 25, 30, 35, 40, 45, 50, 60, 70, 80, 90, 100, 200, 300, 400 or more consecutive nucleotides. In one embodiment, each probe consists of about 25 consecutive nucleotides.

Multiple probes for the same gene can be included in a nucleic acid array of the present invention. For instance, at least 2, 5, 10, 15, 20, 25, 30 or more different probes can be used for detecting the same gene. Each of these different probes can be attached to a different respective region on a nucleic acid array. Alternatively, two or more different probes can be attached to the same discrete region. The concentration of one probe with respect to the other probe or probes in the same region may vary according to the objectives and requirements of the particular experiment. In one embodiment, different probes in the same region are present in approximately equimolar ratio.

In many applications, probes for different genes or RNA transcripts are attached to different respective regions on a nucleic acid array. In some other applications, probes for different genes or RNA transcripts are attached to the same discrete region.

In another embodiment, a nucleic acid array of the present invention includes probes for virulence or antimicrobial resistance genes. As used herein, a probe for a gene can hybridize under stringent or nucleic acid array hybridization conditions to an RNA transcript or a genomic sequence of that gene, or the complement thereof. In many instances, a probe for a gene is incapable of hybridizing under stringent or nucleic acid array hybridization conditions to RNA transcripts or genomic sequences of other genes, or the complements thereof. The virulence or resistance genes that are being detected may be unique for a particular strain, or shared by several strains. Examples of virulence genes include, but are not limited to, various toxin and pathogenesis genes including but not limited to pneumolysin (ply), neuraminidase (nanA), and the choline binding proteins CbpA and PspA. Examples of antimicrobial resistance genes include, but are not limited to, beta-lactamases, tetracycline-resistance genes, macrolide-resistance genes, fluoroquinolone-resistance genes, and glycopeptide drug-resistance genes.

The nucleic acid arrays of the present invention can also include control probes which can hybridize under stringent or nucleic acid array hybridization conditions to respective control sequences, or the complements thereof. Examples of control sequences are depicted in SEQ ID NOs: 7758-7781 and 7916-7924. Typical control sequences include, but are not limited to, probe sequences capable of hybridizing to known sequences under a known conditions, thereby serving as controls for hybridization conditions and the strength of hybridization signals. The control sequences are typically located in a predetermined location; therefore, they may also serve as indicators of address locations on the substrate.

The nucleic acid arrays of the present invention can further include mismatch probes as controls. In many instances, the mismatch residue is located near the center of a probe such that the mismatch is more likely to destabilize the duplex with the target sequence under hybridization conditions. In one embodiment, the mismatch probe is a perfect mismatch probe. Each polynucleotide probe and its corresponding perfect mismatch probe can be stably attached to different respective regions on a nucleic acid array of the present invention.

### Applications of Nucleic Acid Arrays

The arrays of the present invention may be used to detect, identify, distinguish, or quantitate different Streptococcus pneumoniae strains in a sample of interest. A sample of interest can be, without limitation, a food sample, an environmental sample, a pharmaceutical sample, a clinical sample, a blood sample, a human waste sample, a body fluid sample, or any other biological or chemical sample. Because the consensus sequences are derived from the most conserved regions of each ORF, the arrays of the invention are likely to recognize strains not included in the alignments. Additionally, the present invention designs a high number of probes per transcript (e.g., 34 probes each transcript); therefore, the arrays of the invention are capable of detecting novel strains because of greater ORF coverage by the probes. Furthermore, probes for the intergenic sequences allow the detection of unidentified ORFs or other expressible sequences. These intergenic probes are also useful for mapping transcription factor binding sites, identifying operons, promoter and termination sites.

The nucleic acid arrays of the present invention can be used to serotype unknown strains of Streptococcus pneumoniae. Strains can be typed according to their hybridization to specific genes, replacing immunological methods. For example, capsular serotype can be identified based on the profile of signal when DNA is hybridized to the array. In particular, the arrays of the invention can be used to classify strains, especially, epidemic strains in outbreaks. For example, during outbreak, the arrays of the invention can be used to determine if disease-causing strains are of a particular serotype despite clonal vaccination or represent diverse isolates. Typically, the presence of specific virulence markers can be associated with particular forms of invasive disease or with strains causing breakthrough disease in vaccine trials.

The nucleic acid arrays of the present invention can be used to monitor gene expression patterns in multiple strains of Streptococcus pneumoniae.

Protocols for performing nucleic acid array analysis are well known in the art. Exemplary protocols include those provided by Affymetrix® in connection with the use of its GeneChip® arrays. Samples amenable to nucleic acid array analysis include biological samples prepared from human or animal tissues, such as pus, blood, urine, or other body fluid, tissue or waste samples. In addition, food, environmental, pharmaceutical or other types of samples can be similarly analyzed using the nucleic acid arrays of the present invention.

In some embodiments, Streptococcus pneumoniae in a sample of interest are grown in culture before being analyzed by a nucleic acid array of the present invention. In other embodiments, an originally collected sample is directly analyzed without additional culturing.

In many embodiments, the nucleic acid array analysis involves isolation of nucleic acid from a sample of interest, followed by hybridization of the isolated nucleic acid to a nucleic acid array of the present invention. The isolated nucleic acid can be RNA or DNA (e.g., genomic DNA). In one embodiment, the isolated RNA is amplified or labeled before being hybridized to a nucleic acid array of the present invention. Various methods are available for isolating or enriching RNA. These methods include, but are not limited to, RNeasy kits® (provided by QIAGEN), MasterPure™ kits (provided by Epicentre Technologies), and TRIZOL® (provided by Gibco BRL). The RNA isolation protocols provided by Affymetrix® can also be employed in the present invention.

In some embodiments, bacterial mRNA is enriched by removing 16S and 25S rRNA. Different methods are available to eliminate or reduce the amount of rRNA in a bacterial sample. For instance, the MICROBExpress kit™ (provided by Ambion, Inc.) uses oligonucleotide-attached beads to capture and remove rRNA. 16S and 25S rRNA can also be removed by enzyme digestions. According to the latter method, 16S and 25S rRNA are first amplified using reverse transcriptase and specific primers to produce cDNA. The rRNA is allowed to anneal with the cDNA. The sample is then treated with RNAase H, which specifically digests RNA within an RNA:DNA hybrid.

In other embodiments, mRNA is amplified before being subject to nucleic acid array analysis. Suitable mRNA amplification methods include, but are not limited to, reverse transcriptase PCR, isothermal amplification, ligase chain reaction, and Qbeta replicase method. The amplification products can be either cDNA or cRNA.

Polynucleotides for hybridization to a nucleic acid array can be labeled with one or more labeling moieties to allow for detection of hybridized polynucleotide complexes. Example labeling moieties can include compositions that are detectable by spectroscopic, photochemical, biochemical, bioelectronic, immunochemical, electrical, optical or chemical means. Example labeling moieties include radioisotopes, chemiluminescent compounds, labeled binding proteins, heavy metal atoms, spectroscopic markers, such as fluorescent markers and dyes, magnetic labels, linked enzymes, mass spectrometry tags, spin labels, electron transfer donors and acceptors, and the like. In one embodiment, the enriched bacterial mRNA is labeled with biotin. The 5′ end of the enriched bacterial mRNA is first modified by T4 polynucleotide kinase with γ-S-ATP. Biotin is then conjugated to the 5′ end of the modified mRNA using methods known in the art.

Polynucleotides can be fragmented before being labeled with detectable moieties. Exemplary methods for fragmentation include, but are not limited to, heat or ion-mediated hydrolysis.

Hybridization reactions can be performed in absolute or differential hybridization formats. In the absolute hybridization format, polynucleotides derived from one sample are hybridized to the probes in a nucleic acid array. Signals detected after the formation of hybridization complexes correlate to the polynucleotide levels in the sample. In the differential hybridization format, polynucleotides derived from two samples are labeled with different labeling moieties. A mixture of these differently labeled polynucleotides is added to a nucleic acid array. The nucleic acid array is then examined under conditions in which the emissions from the two different labels are individually detectable. In one embodiment, the fluorophores Cy3 and Cy5 (Amersham Pharmacia Biotech, Piscataway, N.J.) are used as the labeling moieties for the differential hybridization format.

Signals gathered from nucleic acid arrays can be analyzed using commercially available software, such as those provide by Affymetrix® or Agilent Technologies. Controls, such as for scan sensitivity, probe labeling and cDNA or cRNA quantitation, may be included in the hybridization experiments. Examples of control sequences includes SEQ ID NOs: 7758-7781 and 7916-7924. The array hybridization signals can be scaled or normalized before being subject to further analysis. For instance, the hybridization signal for each probe can be normalized to take into account variations in hybridization intensities when more than one array is used under similar test conditions. Signals for individual polynucleotide complex hybridization can also be normalized using the intensities derived from internal normalization controls contained on each array. In addition, genes with relatively consistent expression levels across the samples can be used to normalize the expression levels of other genes.

### Protein Arrays

The present invention also features protein arrays for the concurrent or discriminable detection of multiple strains of Streptococcus pneumoniae. Each protein array of the present invention includes probes which can specifically bind to respective proteins of Streptococcus pneumoniae. In one embodiment, the probes on a protein array of the present invention are antibodies. Many of these antibodies can bind to the respective proteins with an affinity constant of at least 10⁴ M⁻¹, 10⁵ M⁻¹, 10⁶ M⁻¹, 10⁷ M⁻¹, or more. In many instances, an antibody for a specified protein does not bind to other proteins. Suitable antibodies for the present invention include, but are not limited to, polyclonal antibodies, monoclonal antibodies, chimeric antibodies, single chain antibodies, Fab fragments, or fragments produced by a Fab expression library. Other peptides, scaffolds, or protein-binding ligands can also be used to construct the protein arrays of the present invention.

Numerous methods are available for immobilizing antibodies or other probes on a protein array of the present invention. Examples of these methods include, but are limited to, diffusion (e.g., agarose or polyacrylamide gel), surface absorption (e.g., nitrocellulose or PVDF), covalent binding (e.g.; silanes or aldehyde), or non-covalent affinity binding (e.g., biotin-streptavidin). Examples of protein array fabrication methods include, but are not limited to, ink-jetting, robotic contact printing, photolithography, or piezoelectric spotting. The method described in MacBeath and Schreiber, Science, 289: 1760-1763 (2000) can also be used. Suitable substrate supports for a protein array of the present invention include, but are not limited to, glass, membranes, mass spectrometer plates, microtiter wells, silica, or beads.

The protein-coding sequence of a gene can be determined by a variety of methods. For instance, many protein sequences can be obtained from the NCBI or other public or commercial sequence databases. The protein-coding sequences can also be extracted from the corresponding tiling or parent sequences by using an open reading frame (ORF) prediction program. Examples of ORF prediction programs include, but are not limited to, GeneMark™ (provided by the European Bioinformatics Institute), Glimmer (provided by TIGR), and ORF Finder (provided by the NCBI). Where a parent or tiling sequence represents the 5′ or 3′ untranslated region of a gene, a BLAST search of the sequence against a genome database can be conducted to determine the protein-coding region of the gene.

In one embodiment, a protein array of the present invention includes at least 2, 5, 10, 20, 30, 40, 50, 100, 200, 300, 400, 500, 1,000, 2,000, 3,000, 4,000, or more probes, each of which can specifically bind to a different respective protein encoded by one or more sequences selected from SEQ ID NOs: 1-5980, 5981-7757, 7782-7870, and 7871-7915 or their corresponding genes.

### Other Forms of Arrays and Kits

The present invention contemplates a collection of polynucleotides. The collection of polynucleotides includes polypeptides capable of hybridizing under stringent or nucleic acid array hybridization conditions to a sequence selected from SEQ ID NOs: 1-5980, 5981-7757, 7782-7870, and 7871-7915, or the complement thereof. In one embodiment, the collection includes two or more different polynucleotides, each of which is capable of hybridizing under stringent or nucleic acid array hybridization conditions to a different respective sequence selected from SEQ ID NOs: 1-5980, 5981-7757, 7782-7870, and 7871-7915, or the complement thereof. In another embodiment, the collection includes one or more sequences depicted in SEQ ID NOs: 1-7924, or one or more tiling sequences derived from SEQ ID NOs: 1-7924, or the complement(s) thereof. In still another embodiment, the collection includes one or more oligonucleotide probes listed in SEQ ID NOs: 7925-254,193. In still another embodiment, the collection includes one or more oligonucleotide probes listed in SEQ ID NOs: 254,194-478,375. The present invention also features kits including the polynucleotides, polynucleotide probes, protein probes of the present invention as described in various embodiments above. In particular, the kits of the invention includes nucleic acid arrays including oligonucleotide probes derived from the consensus sequences and/or exemplar sequences of Streptococcus pneumoniae described above.

It should be understood that the above-described embodiments and the following examples are given by way of illustration, not limitation. Various changes and modifications within the scope of the present invention will become apparent to those skilled in the art from the present description.

### EXAMPLES

### Example 1

### Nucleic Acid Array

The parent sequences depicted in SEQ ID NOs: 1-7924 were used for probe selection using a probe selection algorithm developed by Affymetrix® (Mei R. et al. (2003) “Probe selection for high-density oligonucleotide arrays,” PNAS U.S.A., 100(20):11237-42, the teachings of which are hereby incorporated by reference). Probes with 25 non-ambiguous bases were selected. Thirty-four (34) probe-pairs were requested for each submitted ORF sequence with a minimum number of acceptable probe-pairs set to three. All intergenic sequences derived from the finished genomes based on the public ORF coordinates and greater than 50 bases in length were also submitted for probe selection. A maximal set of 12-15 probes were chosen for each submitted intergenic sequence. The final set of selected probes is depicted in SEQ ID NOs: 7925-254,193. These probes are perfect match probes. The perfect mismatch probe for each perfect match probe was also prepared. The perfect mismatch probe is identical to the perfect match probe except at position 13 where a single-base substitution is made. The substitutions are A to T, T to A, G to C, or C to G. The final custom nucleic acid array, Spneumola array, includes both the perfect match probes and the perfect mismatch probes. In addition, the custom array contains probe sets for control sequences.

### Example 2

### Assessing Genomic Relatedness of Different Serotypes

The Spneumo1 array was utilized to assess genomic relatedness of one or more representatives of some of the serotypes present in 13-valent pneumococcus vaccine as well as control strains for which the complete genome sequence has been determined (e.g., TIGR 4, labeled “T4” in the figures, and R6). The two control strains were obtained from ATCC and the remainder are from Wyeth's strain collection. DNA was extracted, labeled and hybridized to the array using standard methods known in the art. See, e.g., Dunman et al. (2004), “Uses of Staphylococcus aureus GeneChips® in Genotyping and Genetic Composition Analysis,” J. Clin. Microbiology, 42:4275-4283, the teachings of which are hereby incorporated by reference.

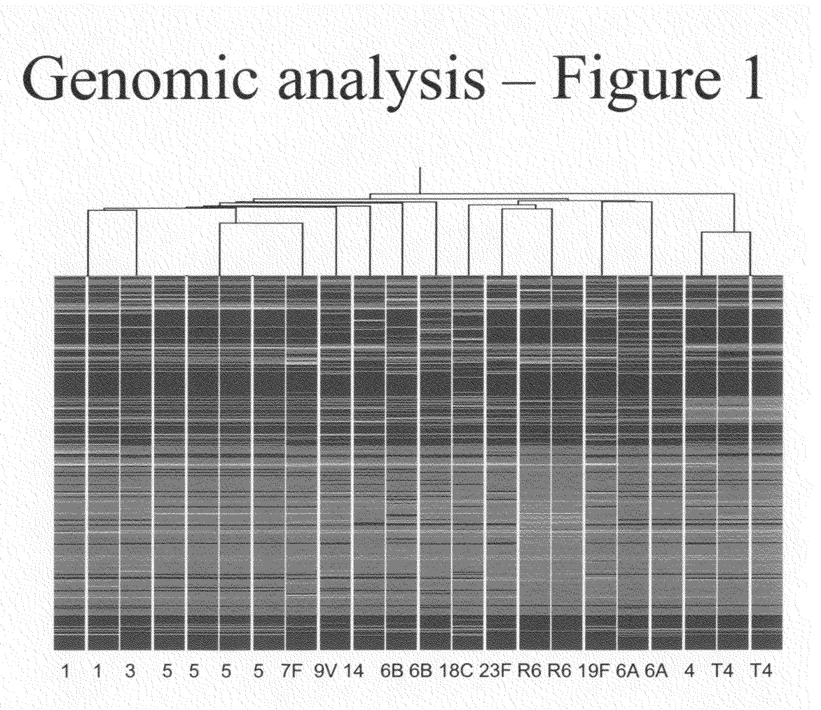

The dendrogram-heat map as shown in FIG. 1 shows DNA similarity between isolates, calculated using correlation methods using log-normalized signals for qualifiers representing ORFS. Each column represents one strain; each row represents a gene. Red indicates a strong signal for a gene present in that strain; blue indicates the gene is absent; and intermediate orange-yellow-green color represents a weaker signal, indicating, perhaps, a gene variant. The several blocks of solid blue are largely comprised of genes derived from capsule operons of serotypes not included in this study. 4,340 genes (rows) are represented in FIG. 1.

FIG. 1 shows that the four serotype 5 strains, the two serotype 1 strains, and the two serotype 6A strains, as well as the replicates of the genome controls, are essentially indistinguishable from one another. In contrast, the dendrogram indicates that the two serotype 6B strains are not closely related to one another. The serotype 4 strain is more closely related to the TIGR 4 strain than to any of the other strains, but it is not identical.

### Example 3

### Serotyping Isolates

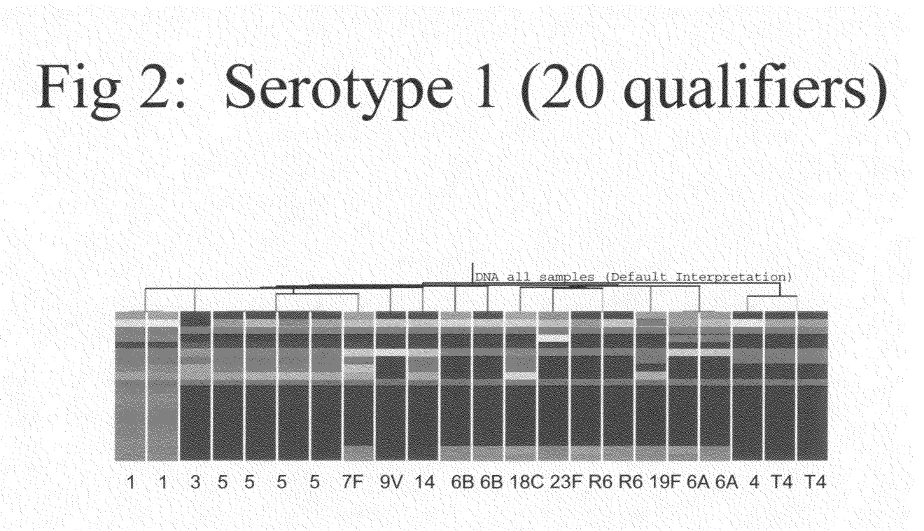

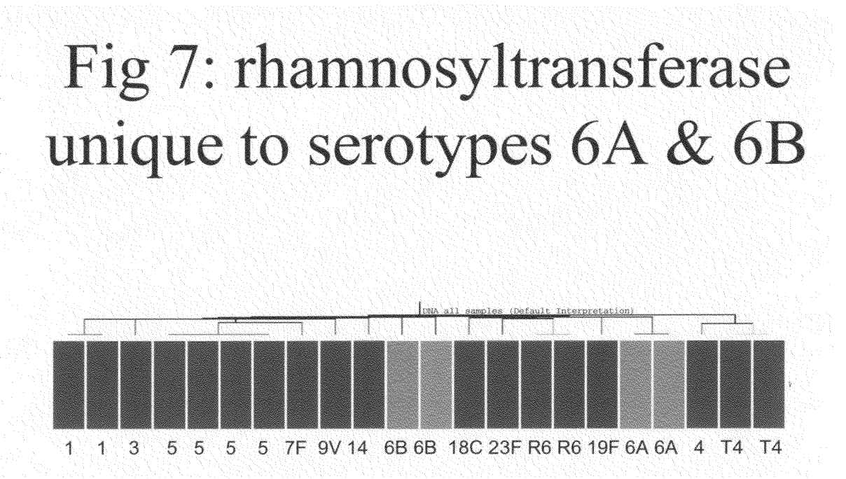

FIGS. 2-7 show that the array of the invention may be used to aid in serotyping isolates, particularly, based on the DNA content of their capsule operons. The heat maps illustrated in FIGS. 2-7 show only those qualifiers predicted to be present in the capsule operons of these selected serotypes. Predictions are based on a comparison of the oligonucleotide probes used on the array and the DNA sequence of each capsule operon. A predicted Present call is made if 70% of the qualifier's probes match the sequence of the capsule operon. In each case, all or most of the qualifiers predicted to be present for a given serotype produce a hybridization signal on the array. It can be seen that some genes are shared by multiple serotypes, while others are unique to a single serotype or shared between closely related serotypes (e.g., serotypes 6A & 6B, FIG. 7).

### Example 4

### Virulence Gene Profiles

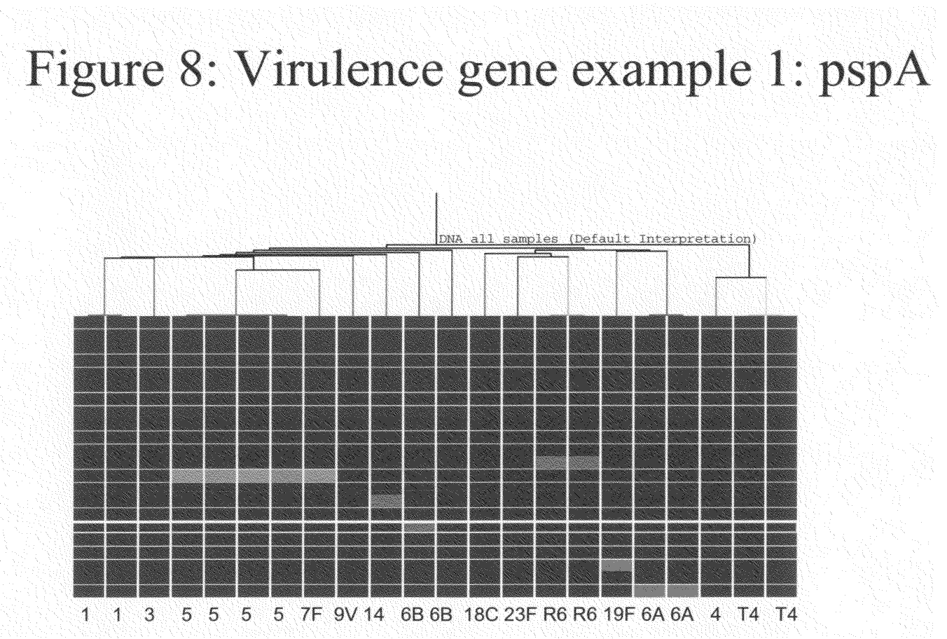

The array of the invention may also be used to detect the presence or absence of specific virulence genes. Examples are shown in FIGS. 8 (detecting the present of pspA) and 9 (detecting the present of pspC). Both of these genes are highly polymorphic and therefore are associated with multiple different qualifiers on the array. Some strains hybridize to one or more of these qualifiers, and some strains lack any of the variants represented on the array.

This method is also applicable to tracking clinical isolates, for example to determine if outbreaks are caused by a single or multiple strains, if different outbreaks are epidemiologically related to one another; and if different serotypes are found in different host backgrounds or in similar ones—the latter indicating serotype switching events.

The qualifiers used in the above experiments and shown in the figures are shown in Table 3. Each qualifier number correspondence to a sequence as listed in the Sequence Listing and identified by a SEQ ID NO.

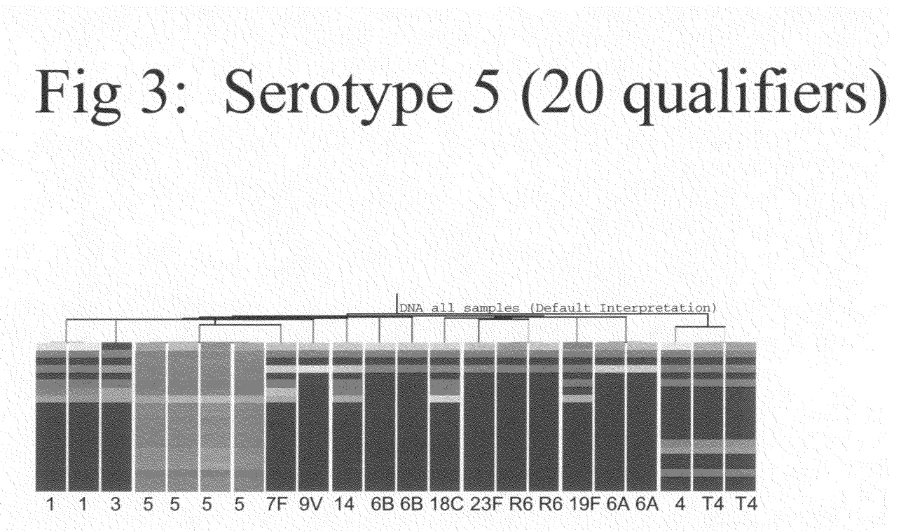

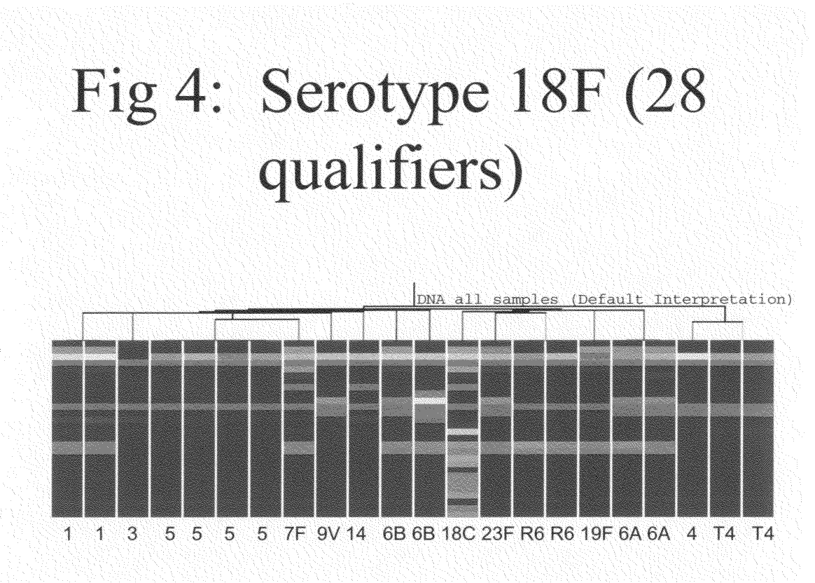

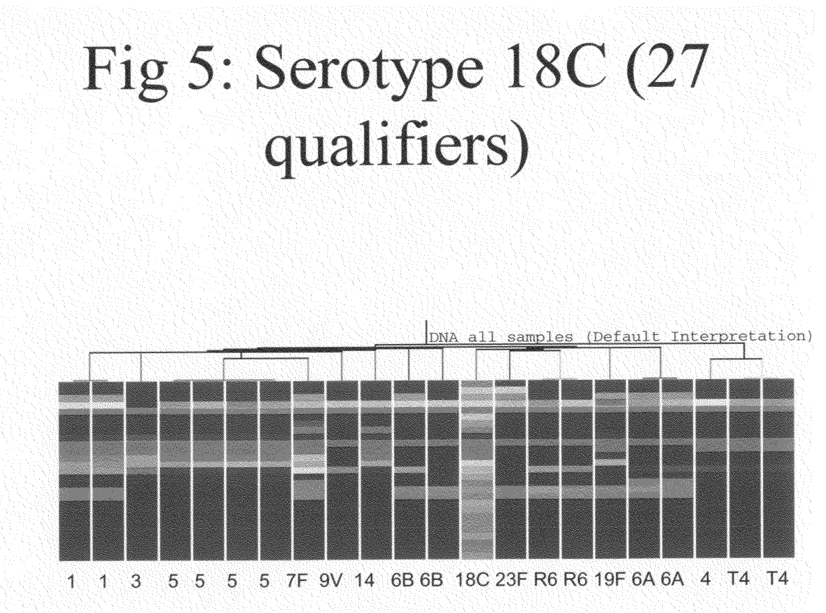

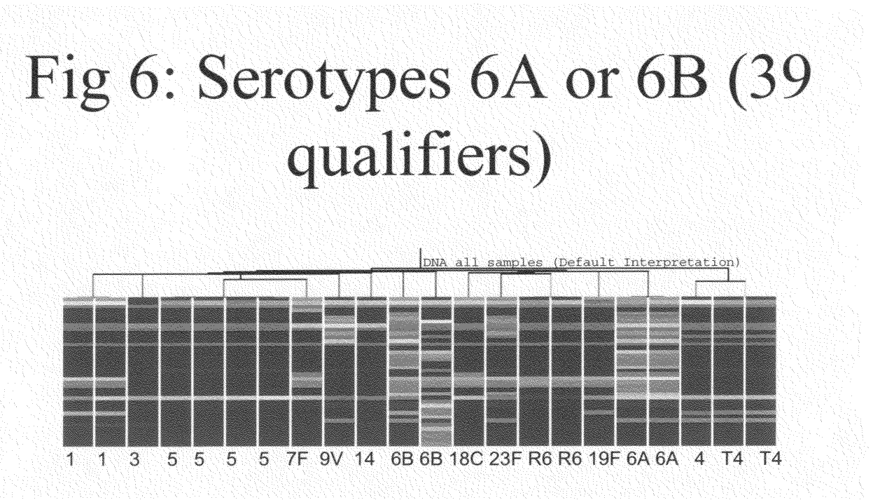

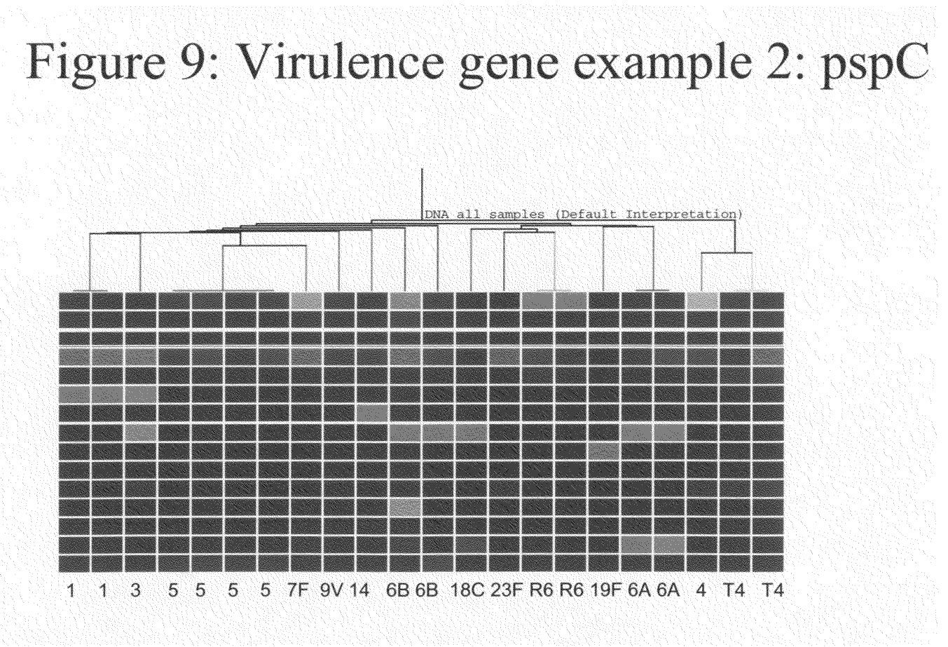

TABLE 3
Sequence Information for Qualifiers

| | | | | | SEQ. | 6A,6B | SEQ. |
|---|---|---|---|---|---|---|---|
| Serotype 18F | SEQ. | Serotype 1 | SEQ. | Serotype 5 | ID | rhamnosyl- | ID |
| (FIG. 4) | ID NO. | (FIG. 2) | ID NO. | (FIG. 3) | NO. | transferase | NO. |
| WAN024AUI_at | 6322 | WAN024AW9_at | 1364 | WAN024AWB_s_at | 6606 | WAN024CD4_at | 2528 |
| WAN024AW9_at | 1364 | WAN024AWB_s_at | 6606 | WAN024AWE_x_at | 4290 | | |
| WAN024AWB_s_at | 6606 | WAN024AWE_x_at | 4290 | WAN024B4K_at | 6817 | | |
| WAN024AWE_x_at | 4290 | WAN024AXY_at | 909 | WAN024B4M_s_at | 2739 | | |
| WAN024AXE_s_at | 16 | WAN024B4M_s_at | 2739 | WAN024B8I_x_at | 7647 | | |
| WAN024AXS_at | 2777 | WAN024B8I_x_at | 7647 | WAN024BHZ_at | 6725 | | |
| WAN024AXZ_at | 907 | WAN024BI7_s_at | 2003 | WAN024BI7_s_at | 2003 | | |
| WAN024B3I_s_at | 2360 | WAN024BI9_s_at | 6258 | WAN024BI9_s_at | 6258 | | |
| WAN024B4L_at | 1736 | WAN024BIJ_x_at | 1704 | WAN024BIG_s_at | 1703 | | |
| WAN024B4N_s_at | 1733 | WAN024BJC_s_at | 6057 | WAN024BIJ_x_at | 1704 | | |
| WAN024BFY_x_at | 3184 | WAN024BRF_at | 6577 | WAN024BRR_at | 7027 | | |
| WAN024BIC_s_at | 6257 | WAN024BRG_at | 6430 | WAN024BRS_at | 6960 | | |
| WAN024BII_at | 1890 | WAN024BRH_at | 6463 | WAN024BRT_at | 6642 | | |
| WAN024BPN_at | 7150 | WAN024BRI_at | 6398 | WAN024BRU_at | 7225 | | |
| WAN024BPO_at | 6719 | WAN024BRJ_at | 6490 | WAN024BRV_at | 6805 | | |
| WAN024ERR_at | 743 | WAN024BRK_at | 6509 | WAN024CK7_at | 775 | | |
| WAN024F8Z-3_at | 46 | WAN024BRL_at | 7374 | WAN024CK8_at | 1771 | | |
| WAN024F8Z-5_at | 1458 | WAN024DJC_at | 6337 | WAN024CKI_at | 6365 | | |
| WAN024FNZ_at | 7023 | WAN024F8Z-3_at | 46 | WAN024CKL_at | 6948 | | |
| WAN024FO2_x_at | 2734 | WAN024F8Z-5_at | 1458 | WAN024CMJ_at | 4931 | | |
| WAN024FOT_at | 1710 | | | WAN024CVZ_at | 7029 | | |
| WAN024FV4_at | 721 | | | WAN024DJE_at | 6336 | | |
| WAN024FV5_at | 990 | | | | | | |
| WAN024FV6_at | 1084 | | | | | | |
| WAN024FV8_at | 2590 | | | | | | |
| WAN024FV9_at | 6728 | | | | | | |
| WAN024FYM_at | 5352 | | | | | | |
| WAN024FYX_at | 3868 | | | | | | |

| | | | SEQ. | | | | |
|---|---|---|---|---|---|---|---|
| Serotypes 6A + 6B | SEQ. | Serotype 18C | ID | pspA | SEQ. | pspC | SEQ. |
| (FIG. 6) | ID NO. | (FIG. 5) | NO. | (FIG. 8) | ID NO. | (FIG. 9) | ID NO. |
| WAN024AW9_at | 1364 | WAN024AUK_at | 684 | WAN024DRN_at | 6470 | WAN024DSR_at | 3092 |
| WAN024AWB_s_at | 6606 | WAN024AUL_s_at | 683 | WAN024DRO_at | 6469 | WAN024DSQ_at | 3097 |
| WAN024AWE_x_at | 4290 | WAN024AW9_at | 1364 | WAN024DRQ_at | 6474 | WAN024DSP_at | 3091 |
| WAN024AY3_at | 913 | WAN024AWB_s_at | 6606 | WAN024DRS_at | 6471 | WAN024DSO_s_at | 3093 |
| WAN024B3E_at | 2838 | WAN024AWE_x_at | 4290 | WAN024DRU_at | 6473 | WAN024DSN_at | 3094 |
| WAN024B3J_at | 1292 | WAN024AXB_at | 2538 | WAN024DRV_at | 6475 | WAN024DSM_at | 3096 |
| WAN024B4N_s_at | 1733 | WAN024AY2_at | 908 | WAN024DRW_at | 6481 | WAN024DSF_at | 3095 |
| WAN024B8I_x_at | 7647 | WAN024B3I_s_at | 2360 | WAN024DRY_at | 6250 | WAN024DSD_at | 2274 |
| WAN024BFY_x_at | 3184 | WAN024B4M_s_at | 2739 | WAN024DRZ_at | 6477 | WAN024DSC_at | 3102 |
| WAN024BI8_at | 3120 | WAN024BFY_x_at | 3184 | WAN024DS2_s_at | 6297 | WAN024DS3_at | 7025 |
| WAN024BIC_s_at | 6257 | WAN024BI7_s_at | 2003 | WAN024DS4_at | 6296 | WAN024DRX_at | 7043 |
| WAN024BIG_s_at | 1703 | WAN024BI9_s_at | 6258 | WAN024DS5_at | 6478 | WAN024DRT_at | 7044 |
| WAN024BJC_s_at | 6057 | WAN024BIJ_x_at | 1704 | WAN024DS6_at | 6480 | WAN024DRR_at | 7041 |
| WAN024BQU_at | 7325 | WAN024CPN_at | 2129 | WAN024DS7_at | 6472 | WAN024DRP_at | 7046 |
| WAN024CCY_at | 985 | WAN024ERQ_at | 745 | WAN024DS8_at | 6479 | WAN024DRM_at | 7042 |
| WAN024CCZ_at | 2131 | WAN024F85_at | 4389 | WAN024DS9_at | 6476 | | |
| WAN024CD4_at | 2528 | WAN024F8Z-3_at | 46 | WAN024DSB_at | 1177 | | |
| WAN024CD7_at | 4142 | WAN024F8Z-5_at | 1458 | WAN024DSG_at | 1183 | | |
| WAN024CDD_at | 1211 | WAN024FNZ_at | 7023 | WAN024DSH_at | 1182 | | |
| WAN024CDF_at | 4289 | WAN024FO2_x_at | 2734 | WAN024DSI_at | 1180 | | |
| WAN024F85_at | 4389 | WAN024FV4_at | 721 | WAN024DSJ_at | 1181 | | |
| WAN024F8V_at | 7657 | WAN024FV5_at | 990 | WAN024DSL_at | 1178 | | |
| WAN024F8Z-3_at | 46 | WAN024FV6_at | 1084 | | | | |
| WAN024F8Z-5_at | 1458 | WAN024FV8_at | 2590 | | | | |
| WAN024FRI_at | 3086 | WAN024FVB_at | 1779 | | | | |
| WAN024FS4_at | 3814 | WAN024FYM_at | 5352 | | | | |
| WAN024AWD_at | 1611 | WAN024FYX_at | 3868 | | | | |
| WAN024B3D_at | 1682 | | | | | | |
| WAN024B3H_at | 1664 | | | | | | |
| WAN024B4L_at | 1736 | | | | | | |
| WAN024B8E_s_at | 37 | | | | | | |
| WAN024BI6_at | 1979 | | | | | | |
| WAN024BIE_at | 49 | | | | | | |
| WAN024BII_at | 1890 | | | | | | |
| WAN024BX5_at | 6850 | | | | | | |
| WAN024C4Z_at | 910 | | | | | | |
| WAN024CCV_s_at | 2863 | | | | | | |
| WAN024CD6_at | 4905 | | | | | | |
| WAN024CDC_at | 2748 | | | | | | |

The foregoing description of the present invention provides illustration and description, but is not intended to be exhaustive or to limit the invention to the precise one disclosed. Modifications and variations consistent with the above teachings may be acquired from practice of the invention. Thus, it is noted that the scope of the invention is defined by the claims and their equivalents.

### INCORPORATION BY REFERENCE

All sequence access numbers, publications and patent documents cited in this application are incorporated by reference in their entirety for all purposes to the same extent as if the contents of each individual publication or patent document were incorporated herein.

We claim:

1. An array comprising a substrate having a plurality of addresses, each address comprising a probe disposed thereon, wherein the array is capable of monitoring gene expression patterns of multiple strains of Streptococcus pneumoniae.

2. The array of claim 1, wherein the probe is an oligonucleotide derived from genomic consensus sequences of Streptococcus pneumoniae using a probe selection algorithm.

3. The array of claim 2, wherein the oligonucleotide has a length of 10-50 bases.

4. The array of claim 2, wherein the probe is a perfect match probe.

5. The array of claim 2, wherein the probe is a mismatch probe comprising at least one mismatch position located at the approximate thermodynamic center of the probe.

6. The array of claim 2, wherein the genomic consensus sequences comprise one or more sequences selected from the group consisting of SEQ ID NOs: 1-5980 and 7782-7870.

7. The array of claim 6, wherein the genomic consensus sequences comprise ten or more sequences selected from the group consisting of SEQ ID NOs: 1-5980 and 7782-7870.

8. The array of claim 7, wherein the genomic consensus sequences comprise one hundred or more sequences selected from the group consisting of SEQ ID NOs: 1-5980 and 7782-7870.

9. The array of claim 2, wherein the genomic consensus sequences comprise SEQ ID NOs: 1-5980 and 7782-7870.

10. The array of claim 1, wherein the array further comprises at least one additional probe derived from exemplar sequences of Streptococcus pneumoniae using a probe selection algorithm.

11. The array of claim 10, wherein the exemplar sequences comprise one or more sequences selected from the group consisting of SEQ ID NOs: 5981-7757 and 7871-7915.

12. The array of claim 10, wherein the exemplar sequences comprise ten or more sequences selected from the group consisting of SEQ ID NOs: 5981-7757 and 7871-7915.

13. The array of claim 10, wherein the exemplar sequences comprise one hundred or more sequences selected from the group consisting of SEQ ID NOs: 5981-7757 and 7871-7915.

14. The array of claim 10, wherein the exemplar sequences comprise SEQ ID NOs: 5981-7757 and 7871-7915.

15. The array of claim 1, wherein the probe is an oligonucleotide derived from SEQ ID NOs: 1-7924 using a probe selection algorithm.

16. The array of claim 1, wherein the array is capable of monitoring gene expression patterns of one or more Streptococcus pneumoniae strains selected from the group consisting of R6, TIGR4, 23F, ATCC55840 and TIGR 670.

17. A method for identifying a serotype of a strain of Streptococcus pneumoniae in a sample, the method comprising the steps of:
exposing the sample to the array of claim 1; and
detecting a gene expression pattern indicative of the serotype.

18. A method for identifying a serotype of a strain of Streptococcus pneumoniae in a sample, the method comprising the steps of:
exposing the sample to the array of claim 6; and
detecting a gene expression pattern indicative of the serotype.

19. A method for detecting the presence of Streptococcus pneumoniae in a sample, the method comprising the steps of:
exposing the sample to the array of claim 1; and
detecting a gene expression pattern indicative of the presence of Streptococcus pneumoniae.

20. A method for detecting the presence of Streptococcus pneumoniae in a sample, the method comprising the steps of:
exposing the sample to the array of claim 6; and
detecting a gene expression pattern indicative of the presence of Streptococcus pneumoniae.

21. The method of claim 20, wherein the sample is a biological sample from a patient and the Streptococcus pneumoniae is a disease-associated strain.

22. The method of claim 20, wherein the sample is from a culture of Streptococcus pneumoniae.

23. A method for monitoring gene expression of Streptococcus pneumoniae, the method comprising the steps of:
exposing a sample derived from a strain of Streptococcus pneumoniae to the array of claim 1; and
detecting a signal indicative of a gene expression pattern of the strain.

24. A method for monitoring gene expression of Streptococcus pneumoniae, the method comprising the steps of:
exposing a sample derived from a strain of Streptococcus pneumoniae to the array of claim 6; and
detecting a signal indicative of a gene expression pattern of the strain.
